(19) United States
(12) Patent Application Publication
(10) Pub. No.: US 2013/0013889 A1
(43) Pub. Date: Jan. 10, 2013

(54) Memory management unit using stream identifiers

(76) Inventors: Jaikumar Devaraj, Bangalore (IN); Viswanath Chakrala, Bangalore (IN); Stuart David Biles, Bury St Edmunds (GB); Shrilola Chitrapadi, Bangalore (IN)

(21) Appl. No.: 13/067,912

(22) Filed: Jul. 6, 2011

(51) Int. Cl. G06F 12/10

(52) U.S. Cl. 711/207; 711/E12.061

(57) ABSTRACT

A memory management unit includes a translation buffer unit for storing memory management attribute entries that originate from a plurality of different memory management contexts. Context disambiguation circuitry responds to one or more characteristics of a received memory transaction to form a stream identifier and to determine which of the memory management context matches that memory transaction. In this way, memory management attribute entries stored within the translation lookaside buffer are formed under control of the appropriate matching context. When the translation buffer unit receives a further transaction, then a further stream identifier is formed therefrom and if this matches the stream identifier of stored memory management attribute entries then those memory management attribute entries may be used (if appropriate) for that further memory transaction.

### BACKGROUND OF THE INVENTION

1. Field of the Invention

This invention relates to the field of data processing systems. More particularly, this invention relates to memory management units for data processing systems.

2. Description of the Prior Art

It is known to provide data processing systems with memory management units which serve to manage access to memory. For example, a memory management unit may be responsible for translating virtual addresses to physical addresses and for managing access permissions and other attributes, such as cacheability and bufferability. In typical systems it is the responsibility of the operating system software to program the necessary data and configuration to be used by the memory management unit. For example, the operating system may control the mapping between virtual addresses and physical addresses to be used by different application programs that are executed in conjunction with the operating system.

Some devices, such as direct memory access units, graphics processing units, input/output devices and the like may generate physical addresses not requiring virtual-to-physical translation, but may nevertheless require other services, such as those controlling access permissions. Providing such additional devices are appropriately configured (usually under control of the operating system) they may operate successfully in combination with the other elements within the system. In other situations, some devices may require the illusion of a contiguous memory space which is unavailable in the system due to fragmentation of memory. Such devices may require virtual-to-physical translation or scatter gather DMA functionality.

It is also known in the field of data processing systems to virtualise the execution environment. For example, FIG. 1 of the accompanying drawings illustrates a virtualised system in which a hypervisor program controls execution of three different operating system programs and each of those operating system programs itself controls execution of one or more application programs. A problem in this context is that each operating system may have its own individual virtual-to-physical address mappings and set of access permissions that are not uniform across the operating systems. Accordingly, memory management unit hardware would require reprogramming and reconfiguring each time a different operating system was allocated to execute by the hypervisor. Furthermore, devices not directly controlled by the operating systems, such as direct memory access devices would likely also require intervention by the hypervisor each time an operating system required use of those devices in order that those devices would generate the appropriate addresses and utilise the appropriate permissions and configurations.

### SUMMARY OF THE INVENTION

Viewed from one aspect the present invention provides a memory management unit for managing memory accesses using a plurality of different memory management contexts, each of said plurality of different memory management contexts defining how memory access is controlled for memory transactions associated therewith, said memory management unit comprising:

a translation buffer unit having a translation lookaside buffer configured to store a plurality of memory management attributes entries to be applied to transactions received from one or more transaction masters prior to being sent to one or more transaction slaves, said memory management attributes comprising at least one of address translation attributes, memory access attributes and access permission attributes; and

context disambiguation circuitry configured to respond to one or more characteristics of a memory transaction received from one of said one or more transactions masters to form a stream identifier and to determine which of said plurality of different memory management contexts is a matching context to be used with memory transactions having said stream identifier such that memory management attributes entries stored within said translation lookaside buffer for use with said memory transaction are formed under control of said matching context; wherein

said translation buffer unit is configured to store at least a portion of said stream identifier produced by said context disambiguation circuitry, to respond to one or more characteristics of a further memory transaction received by said translation buffer unit to form a further stream identifier therefrom and, if said further stream identifier matches said stream identifier, then to use for said further memory transaction any memory management attributes entries stored within said translation lookaside buffer corresponding to said stream identifier.

The present technique utilises context disambiguation circuitry to form a stream identifier from a received transaction and to match this with a memory management context which is then used to control forming of the memory management attribute entries to be stored within the translation lookaside buffer of the memory management unit. When a further transaction is received, then a further stream identifier may be formed therefrom and if this stream identifier matches a stream identifier already associated with some memory attribute entries stored within the transaction lookaside buffer, then those memory management attribute entries may be used for the further transaction assuming that they match in other respects (e.g. relate to the same regions of virtual address space).

The context disambiguation circuitry and the translation buffer unit may be formed together as part of the memory management unit. However, in some embodiments the context disambiguation circuitry is part of a translation control unit with that translation control unit being devolved certain tasks, such as performing a page table walk operation using page table data stored in a memory to determine at least part of the memory management attribute entries.

The context disambiguation circuitry may further comprise a stream mapping table containing entries that provide a mapping between at least one stream identifier and a memory management context to be used with memory transactions matching that stream identifier. The memory management context may provide data such as pointers to a page table base address, memory management unit configuration parameters and the like.

The stream identifier which is stored within the translation buffer unit may in some embodiments comprise a stream identifier value and a stream mask value with the stream mask value controlling which parts of the stream identifier value are significant in determining a match with the stream identifier value. Accordingly, the stream mask value may indicate that certain bits are not significant and need not match when a further stream identifier is compared with a stream identifier stored within the translation buffer unit to determine whether or not that further stream identifier matches the stream identifier stored within the translation buffer unit. This increases the flexibility with which stream identifiers may be formed and matched against one another.

In some embodiments each memory management attribute entry within the translation lookaside buffer may store its own stream identifier associated with that memory management attribute entry. In other embodiments the translation buffer unit may store a plurality of stream identifiers each associated with one or more memory attribute entries within the translation lookaside buffer and at least one of the plurality of stream identifiers being associated with a plurality of memory management attribute entries. In further embodiments a translation buffer unit may store a single stream identifier which is associated with all memory management attribute entries within the translation lookaside buffer of that memory management unit such that if a further stream identifier does not match the stored stream identifier then an option to flush the translation lookaside buffer may be provided or the transaction corresponding to the further stream identifier may be passed to the translation control unit for further processing. These different possibilities provide a spectrum in the granularity with which the stream identifier is stored in relation to the memory management attribute entries, i.e. for individual entries, for groups of entries or for all entries.

In a similar way the granularity of storage may be varied for one or more of a context index value identifying a memory management context associated with memory management attribute entries, an application space identifier identifying a thread of program execution associated with memory management attribute entries or a virtual machine identifier identifying a virtual machine execution environment associated with memory management attribute entries. The granularity may be varied from individual storage with each entry, with a group of entries or all entries within a translation buffer unit.

It will be appreciated that a memory management unit could be dedicated to an individual transaction master, however, in other embodiments a plurality of transaction masters may be coupled to an individual memory management unit.

In some embodiments a plurality of translation buffer units, each associated with a different transaction master, may be coupled with a shared translation control unit connected via a communication channel to all of the translation buffer units. This allows a single translation control unit to control multiple translation buffer units thereby reducing the circuit and configuration overhead.

Viewed from another aspect the present invention provides memory management unit for managing memory accesses using a plurality of different memory management contexts, each of said plurality of different memory management contexts defining how memory access is controlled for memory transactions associated therewith, said memory management unit comprising:

translation buffer means for buffering translation data and having translation lookaside buffer means for storing a plurality of memory management attributes entries to be applied to transactions received from one or more transaction masters prior to being sent to one or more transaction slaves, said memory management attributes comprising at least one of address translation attributes, memory access attributes and access permission attributes; and

context disambiguation means for responding to one or more characteristics of a memory transaction received from one of said one or more transactions masters to form a stream identifier and to determine which of said plurality of different memory management contexts is a matching context to be used with memory transactions having said stream identifier such that memory management attributes entries stored within said translation lookaside buffer means for use with said memory transaction are formed under control of said matching context; wherein

said translation buffer means is configured to store at least a portion of said stream identifier produced by said context disambiguation means, to respond to one or more characteristics of a further memory transaction received by said translation buffer unit to form a further stream identifier therefrom and, if said further stream identifier matches said stream identifier, then to use for said further memory transaction any memory management attributes entries stored within said translation lookaside buffer corresponding to said stream identifier.

Viewed from a further aspect the present invention provides a method of operating a memory management unit for managing memory accesses using a plurality of different memory management contexts, each of said plurality of different memory management contexts defining how memory access is controlled for memory transactions associated therewith, said method comprising the steps of:

buffering translation data within a translation buffer unit having a translation lookaside buffer storing a plurality of memory management attributes entries to be applied to transactions received from one or more transaction masters prior to being sent to one or more transaction slaves, said memory management attributes comprising at least one of address translation attributes, memory access attributes and access permission attributes;

responding to one or more characteristics of a memory transaction received by context disambiguation circuitry from one of said one or more transactions masters by forming a stream identifier and determining which of said plurality of different memory management contexts is a matching context to be used with memory transactions having said stream identifier such that memory management attributes entries stored within said translation lookaside buffer for use with said memory transaction are formed under control of said matching context;

storing at least a portion of said stream identifier produced by said context disambiguation circuitry within said translation buffer unit;

responding to one or more characteristics of a further memory transaction received by said translation buffer unit to form a further stream identifier therefrom; and

if said further stream identifier matches said stream identifier, then using for said further memory transaction any memory management attributes entries stored within said translation lookaside buffer corresponding to said stream identifier.

Viewed from a further aspect the present invention provides a memory management unit for managing memory accesses using a plurality of different memory management contexts, each of said plurality of different memory management contexts defining how memory access is controlled for memory transactions associated therewith, said memory management unit comprising:

a translation buffer unit having a translation lookaside buffer configured to store a plurality of memory management attributes entries to be applied to transactions received from one or more transaction masters prior to being sent to one or more transaction slaves, said memory management attributes comprising at least one of address translation attributes, memory access attributes and access permission attributes; wherein

said translation buffer unit stores one or more context parameter data entries at least partially identifying memory management attributes associated with a plurality memory management attributes entries within said translation lookaside buffer and, if a context parameter data entry is modified, then at least one of: all memory management attributes entries associated with said context parameter data entry within said translation lookaside buffer are flushed; and a memory transaction associated with said context parameter data entry that is modified is sent elsewhere for processing.

In some embodiments the translation buffer unit stores one or more context parameter data entries which at least partially identify memory management attributes associated with a plurality of memory management attribute entries within a translation lookaside buffer. For example, all of the memory management attribute entries may share the same virtual machine identifier and accordingly this virtual machine identifier may be saved as context parameter data associated with the translation buffer unit as a whole. In such a system, if a change is made to context parameter data then the translation buffer unit is configured to flush all memory management attribute entries that are associated with that changed context parameter data entry.

The context parameter data may take a wide variety of different forms and in some embodiments may include a context index value identifying a memory management context associated with a plurality of memory management attribute entries within the translation lookaside buffer, an application space identifier identifying a thread of program execution associated with a plurality of memory management attribute entries within the translation lookaside buffer, and a virtual machine identifier, identifying a virtual machine execution environment associated with a plurality of memory management attribute entries within the translation lookaside buffer.

Viewed from a further aspect the present invention provides a memory management unit for managing memory accesses using a plurality of different memory management contexts, each of said plurality of different memory management contexts defining how memory access is controlled for memory transactions associated therewith, said memory management unit comprising:

translation buffer means for buffering translation data and having translation lookaside buffer means for storing a plurality of memory management attributes entries to be applied to transactions received from one or more transaction masters prior to being sent to one or more transaction slaves, said memory management attributes comprising at least one of address translation attributes, memory access attributes and access permission attributes; wherein

said translation buffer means stores one or more context parameter data entries at least partially identifying memory management attributes associated with a plurality of memory management attributes entries within said translation lookaside buffer means and, if a context parameter data entry is modified, then at least one of: all memory management attributes entries associated with said context parameter data entry said within said translation lookaside buffer means are flushed; and a memory transaction associated with said context parameter data entry that is modified is sent elsewhere for processing.

Viewed from a further aspect the present invention provides a method of operating a memory management unit for managing memory accesses using a plurality of different memory management contexts, each of said plurality of different memory management contexts defining how memory access is controlled for memory transactions associated therewith, said method comprising the steps of:

buffering translation data within a translation buffer unit having a translation lookaside buffer for storing a plurality of memory management attributes entries to be applied to transactions received from one or more transaction masters prior to being sent to one or more transaction slaves, said memory management attributes comprising at least one of address translation attributes, memory access attributes and access permission attributes;

storing within said translation buffer unit one or more context parameter data entries at least partially identifying memory management attributes associated with a plurality of memory management attributes entries within said translation lookaside buffer; and

if a context parameter data entry is modified, then at least one of: flushing all memory management attributes entries associated with said context parameter data entry within said translation lookaside buffer means; and sending elsewhere for processing a memory transaction associated with said context parameter data entry that is modified.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a software hierarchy within a data processing system utilising multiple operating systems and execution environment virtualisation;

FIG. 2 schematically illustrates a central processing unit and memory management unit supporting multiple levels of address mapping;

FIG. 3 schematically illustrates multiple levels of memory management;

FIG. 4 schematically illustrates multiple levels of address mapping;

FIG. 5 schematically illustrates a system memory management unit;

FIG. 6 schematically illustrates a data processing system incorporating multiple memory management units;

FIGS. 7, 8, 9 and 10 schematically illustrate various example topologies utilising memory management units;

FIG. 11 illustrates an example topology using separate translation buffer units and a translation control unit;

FIGS. 12, 13, 14 and 15 schematically illustrate various example forms of a translation buffer unit;

FIGS. 16, 17, 18 and 19 illustrate memory management attribute data entries and context parameter data entries that may be stored in different example embodiments;

FIG. 20 schematically illustrates a process flow for a memory management unit supporting multiple stages of memory management control;

FIG. 21 is a flow diagram schematically illustrating stream identifier matching within a translation buffer unit;

FIG. 22 is a flow diagram schematically illustrating query processing within a translation control unit;

FIG. 23 is a flow diagram schematically illustrating memory management attribute data flushing; and

FIG. 24 is a pseudocode representation of stream identifier matching using a stream identifier value and a stream mask value.

### DESCRIPTION OF THE EMBODIMENTS

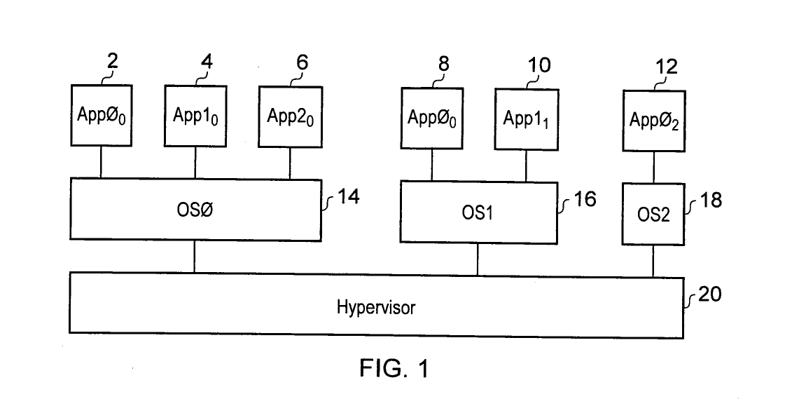

FIG. 1 schematically illustrates a software hierarchy that may be used in a system employing virtualisation. Individual application programs 2, 4, 6, 8, 10, 12 execute in cooperation with respective operating systems 14, 16, 18. A hypervisor program 20 serves to control which operating system program 14, 16, 18 executes at a particular time and to control access to the hardware resources by the operating system programs 14, 16, 18. Thus, the operating systems program 14, 16, 18 control the access to hardware resources by respective application programs 2, 4, 6, 8, 10, 12 and the hypervisor program 20 controls the access to physical resources by the operating system programs 14, 16, 18. The hypervisor program 20 is thus able to provide a virtual execution environment to each of the operating system programs 14, 16, 18.

As an example, an operating system 14, 16, 18 may provide virtual-to-physical address translation on behalf of its associated application programs 2, 4, 6, 8, 10, 12 and then the hypervisor program 20 provides address translation from the addresses generated by the operating system programs 14, 16, 18, which are in fact intermediate physical addresses, to real physical addresses to be applied to the underlying hardware.

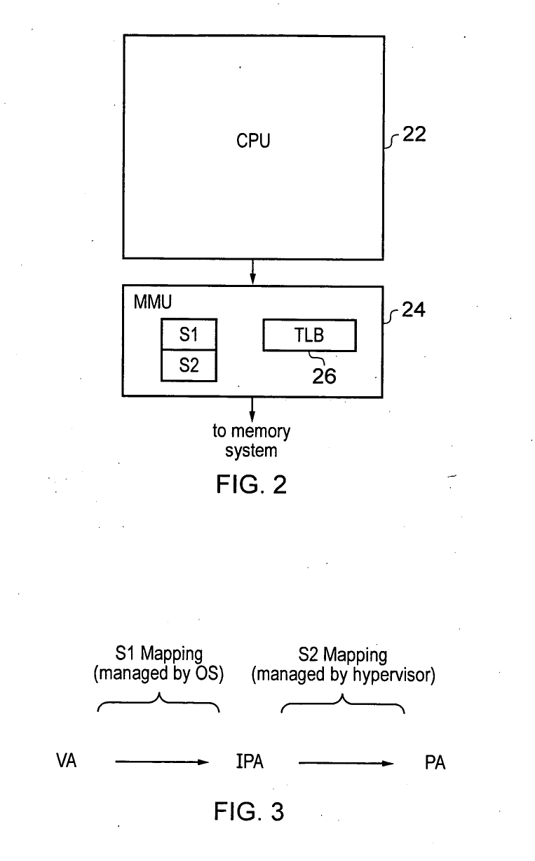

FIG. 2 schematically illustrates a central processing unit 22 coupled to a memory management unit 24 that is responsible for managing memory access in respect of memory transactions generated by the central processing unit 22 directed towards a memory system (not illustrated). The memory management unit 24 includes a translation lookaside buffer 26 storing a plurality of memory management attribute entries. Each of these entries may comprise one or more of address translation attributes (e.g. virtual-to-physical address mapping data), memory access attributes (e.g. cacheability, bufferability, read only etc) and access permission attributes (e.g. security permissions, privilege level requirements etc).

The memory management unit 24 supports two stages of memory management. The first stage S1 is configured by one of the operating system programs 14, 16, 18 and controls the memory management on behalf of that operating system program 14, 16, 18. As an example, the S1 management may perform address translation from virtual addresses (VA) as generated by the application programs 2, 4, 6, 8, 10, 12 to intermediate physical addresses (IPA) as generated by the operating system program 14, 16, 18 and applied to the virtual machine execution environment provided to that operating system program 14, 16, 18 by the hypervisor program 20.

The second stage S2 of memory management provided by the memory management unit 24 is configured by the hypervisor program 20 and maps between the virtual machine execution environment provided to the operating system program 14, 16, 18 and the real physical environment provided by the underlying hardware. Thus, for example, the stage two S2 management may map between intermediate physical addresses (IPA) and real physical addresses (PA). The stage one S1 management is configured by the operating system program 14, 16, 18 and the stage two S2 management is configured by the hypervisor program 20.

FIG. 3 schematically illustrates two stages of address translation which may be managed by the memory management unit 24 in converting a virtual address VA generated by an application program 2, 4, 6, 8, 10, 12 into a real physical address PA to be applied to the hardware. This mapping proceeds via an intermediate physical address IPA corresponding to an address that would be used within the virtual machine execution environment provided by the hypervisor program 20 to the relevant operating system program 14, 16, 18. It will be appreciated that in practice the memory management unit 24 may be programmed such that this two stage mapping in fact takes place in one operation and the intermediate physical address IPA is not generated.

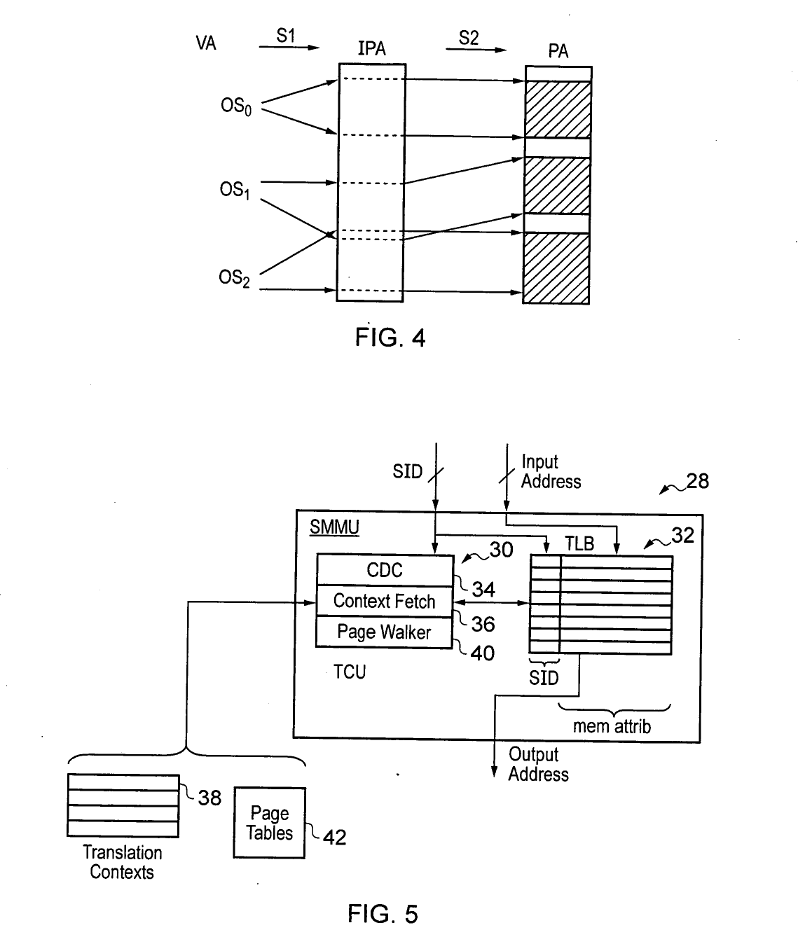

FIG. 4 schematically illustrates the translation from virtual addresses produced by application programs into physical addresses applied to the underlying hardware. In the first stage S1 of translation the operating system programs 14, 16, 18 translation the virtual addresses VA into immediate physical addresses IPA. These intermediate physical addresses produced by the different operating system programs 14, 16, 18 may in fact overlap in an inappropriate manner as the operating system programs 14, 16, 18 are unaware of each other. The second stage of address translation takes the intermediate physical addresses IPA and maps these to real physical addresses PA which are applied to the underlying hardware. The hypervisor program 20 is aware of the different operating system programs 14, 16, 18 can remap the intermediate physical addresses they use into real physical addresses PA which are properly separated from one another. It may be that the hypervisor program 20 overlaps some of the real physical addresses generated by the different operating program systems 14, 16, 18 if it is intended that those operating system programs 14, 16, 18 share data, or for other reasons.

FIG. 5 schematically illustrates a memory management unit 28 including a translation control unit 30 and a translation lookaside buffer 32, which can be considered to logically form part of a translation buffer unit. The overall action of the memory management unit 28 is to convert input addresses to output addresses and to apply the relevant memory access permissions and memory access attributes. The memory management unit 28 may perform stage one S1 management operation, stage two S2 management operation or a combined stage one and stage two S1+S2 management operation. Illustrated in FIG. 5 is the receipt of a stream identifier SID in parallel with the input address. This stream identifier may be formed by reading as a dedicated sideband signal or by derivation from other characteristics of the memory transaction received by the memory management unit 28. The stream identifier is passed to context disambiguation circuitry 32 as well as to the translation lookaside buffer 32.

If it is the first time that a memory transaction with a stream identifier SID matching the received stream identifier has been encountered by the memory management unit 28 (including the possibility that such a stream identifier has been previously encountered but its data flushed), then there will not be a hit within the translation lookaside buffer 32. The context disambiguation circuitry 34 will accordingly form the new stream identifier (including a stream identifier value and an associated mask value as will be discussed later) which is used to identify memory transactions from a particular transaction master which should be managed using the same context of memory management data, e.g. using the same parameters pointing to the associated page table, permission data, memory management unit configuration etc. Context fetch circuitry 36 fetches this context parameter data from the memory where a plurality of translation context 38 are stored. Page walker circuitry 40 performs a page table walk through page table data 42 stored within the memory to determine memory management attribute data to be stored within the translation lookaside buffer 32. This memory management attribute data may comprise one or more of address translation attributes, memory access attributes and access permission attributes. It is also possible that the memory management attribute data may contain further information.

When a further memory transaction is received by the memory management unit 28, it is passed to the translation lookaside buffer where its stream identifier is compared with all of the stream identifiers stored within the translation lookaside buffer. If there is a match between the stream identifier of the further memory transaction and a stream identifier stored within the translation lookaside buffer, then the memory management attribute data for that entry may be used if it matches in other respects to the further memory transaction (e.g. the input address is one for which the memory management data is stored within the translation lookaside buffer 32). It is possible that even if the stream identifiers match, then there may be a miss within the translation lookaside buffer 32 as the particular input address of the further memory transaction does not match an address for which the memory management attribute data is stored within the translation lookaside buffer 32 even though the source of the further memory transaction using the stream identifier has been encountered before and the memory management unit 28 is already storing some of the memory management attribute data for that source in association with the context parameter data relevant to that source.

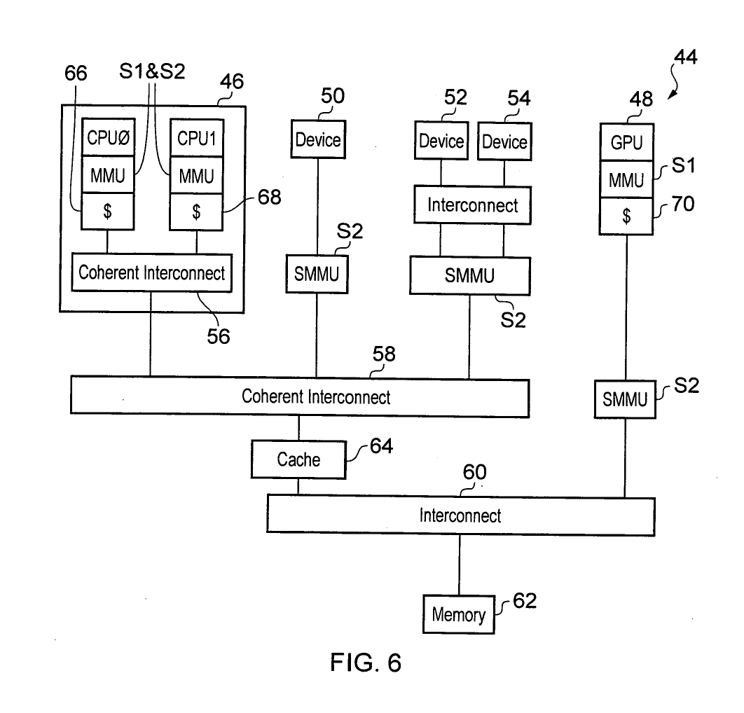

FIG. 6 schematically illustrates a data processing system 44 utilising multiple memory management units. The data processing system 44 includes a dual core processor 46, a graphics processing unit 48, multiple devices 50, 52, 54 (e.g. DMA units, NIC units, I/O units) which may serve as transaction masters, all connected via a series of interconnects 56, 58, 60 to a memory 62. A cache memory 64 may also be connected within the system for shared use as well as individual local caches 66, 68, 70 used by individual transaction masters.

The dual core processor 46 executes application programs using a plurality of operating system programs and a hypervisor program. Accordingly, the memory management units within the dual core processor 46 which are provided for each of the cores, are configured to perform both stage one and stage two S1+S2 translations and management in order to move from the virtual addresses produced by the application programs into the real physical addresses for addressing the memory 62. The devices 50, 52, 54 are programmed under control of one of the operating system programs such that they generate what may be considered to be intermediate physical addresses. These intermediate physical addresses are translated into real physical addresses by memory management units performing a stage two translation. The graphics processing unit 48 has its own memory management unit for performing memory management operations prior to memory transactions reaching its local cache 70. If the memory transactions need to progress further, then a memory management unit applies a second stage of memory management and translation before the memory transactions reach the memory 62.

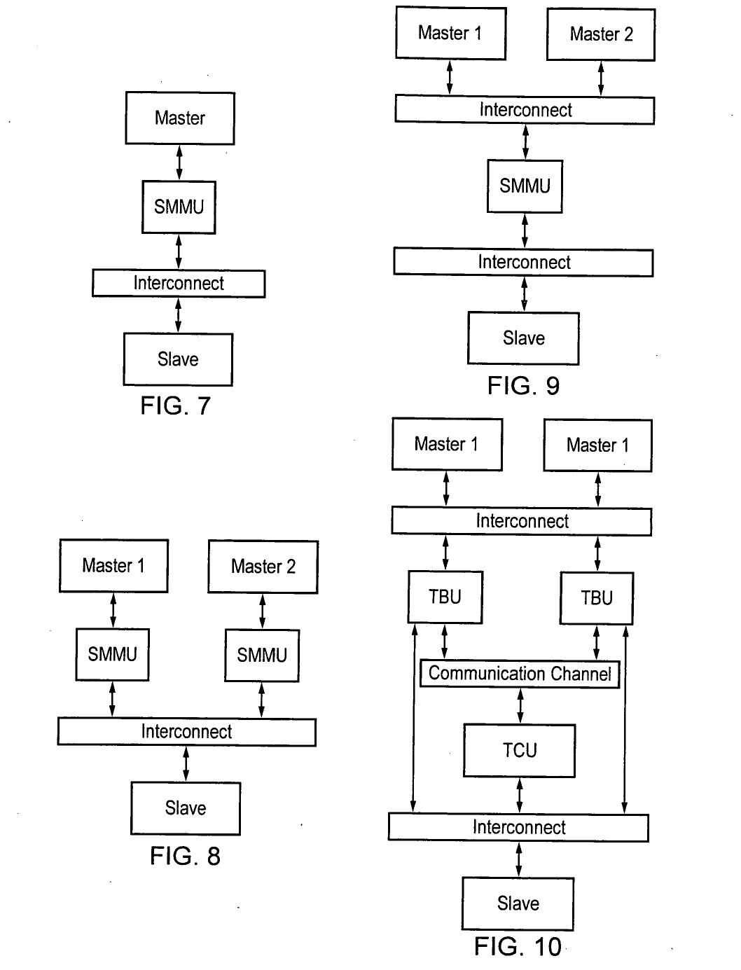

FIGS. 7, 8, 9 and 10 schematically illustrate different topologies within which the memory management units of the present technique may be used. In FIG. 7 a single transaction master communicates with a single transaction slave through a memory management unit and an interconnect. The memory management unit may support both stage one and stage two management in order to support virtualisation within the transaction master.

FIG. 8 illustrates an example topology in which two transaction masters each have their own memory management unit and communicate via an interconnect with a shared transaction slave. Each of the memory management units will be separately configured and controlled and will perform memory management operations in respect of its own transaction master.

FIG. 9 illustrates an example topology in which two transaction masters are connected via an interconnect to a shared memory management unit which communicates with a shared slave. In this case, the overhead associated with the provision of the memory management unit is reduced compared to FIG. 8, but the programming and configuration of the memory management logic unit needs to be coordinated between the transaction masters.

FIG. 10 illustrates a further topology. In this example, the shared memory management unit of FIG. 9 has been broken down into individual translation buffer units which are provided in respect of each of the two transaction masters and a shared translation control unit. The translation control unit communicates via a communication channel with each of the individual translation buffer units. The translation buffer units may be local to, and accordingly rapidly accessed by, the respective transaction masters. The translation control unit performs higher level configuration and control of the translation buffer units and the overhead associated with the translation control unit is shared between the transaction masters.

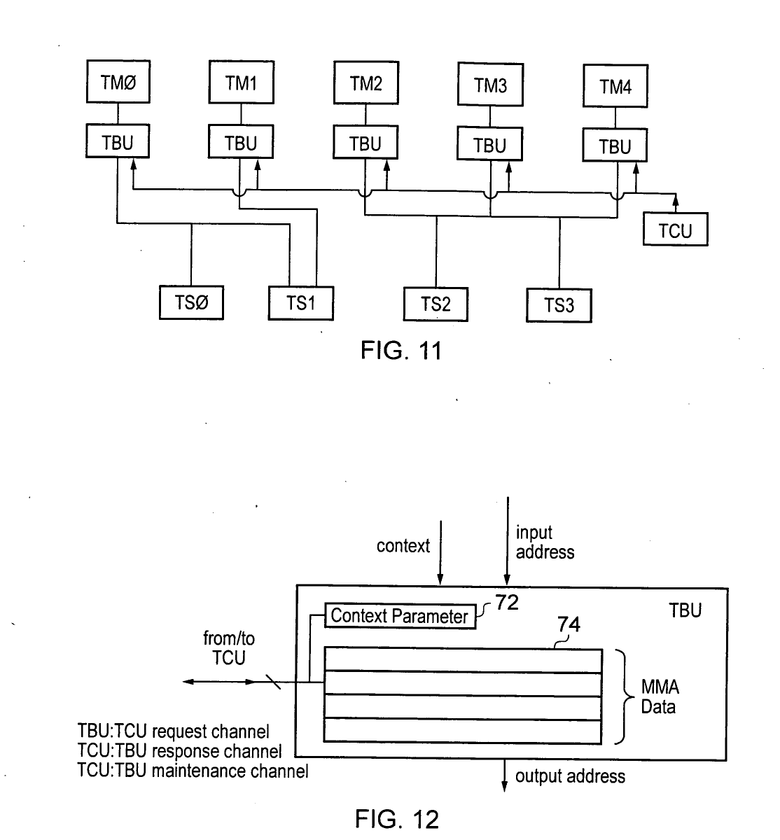

FIG. 11 schematically illustrates a further data processing system employing five transaction masters and four transaction slaves. Each of the transaction masters has an associated translation buffer unit, which will include its own translation lookaside buffer and storage for context parameter data. A shared translation control unit controls the configuration and management of the individual translation buffer units via a communication channel. The translation buffer units may send requests to the translation control unit for data if they receive a memory transaction which they cannot process. Memory faults may also be referred to the translation control unit. The translation control unit can send responses to the translation buffer units, e.g. sending them memory management attribute data and associated context parameter data. The translation control unit may also send maintenance operations to the translation buffer units, e.g. instructing flushing of certain context parameter data or memory management attribute data due to changes in that context parameter data or memory management attribute data that have been detected by the translation control unit.

FIG. 12 schematically illustrates one example of a translation buffer unit. In this example an input address and associated context information (stream identifier) is received and serves to generate an output address which is passed onto the transaction slaves. Within the translation buffer unit, a single set of context parameter data is stored within a register 72 and applies to all of the memory management attribute data entries stored within their respective registers 74. If a change is made to the context parameter data either stored within the translation buffer unit itself or noted by the translation control unit and communicated to the translation buffer unit, then all of the memory management attribute data stored within the register 74 may be flushed as well as the context parameter data stored within the register 72. The flushed data need not be written back to the memory and may simply be marked as invalid.

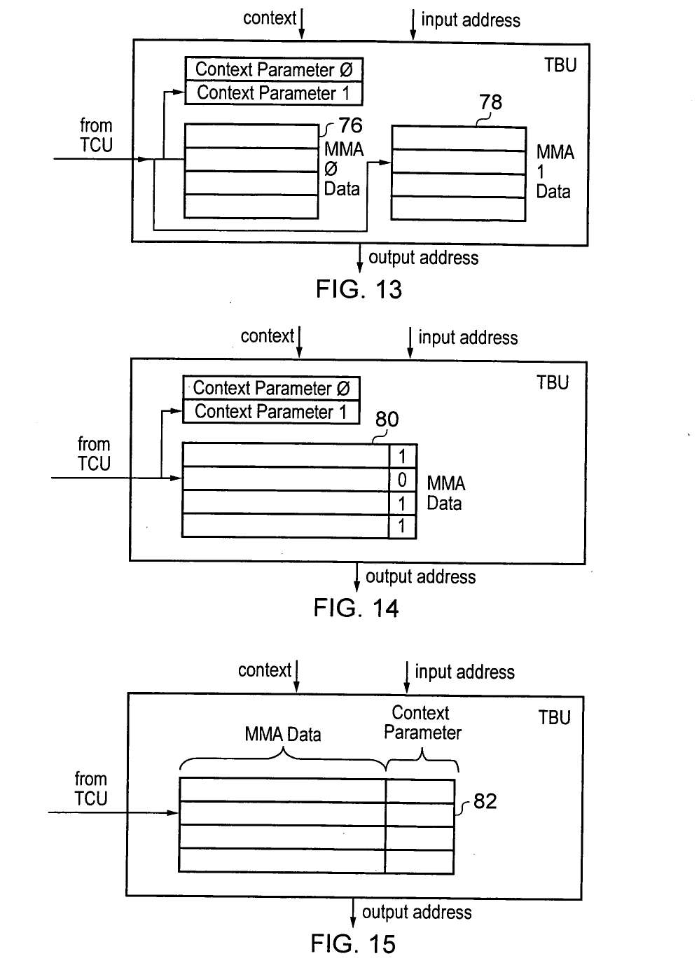

FIG. 13 illustrates an example of a translation buffer unit. In this example two sets of context parameter data are stored. Each set of contact parameter data is associated with a respective bank of registers 76, 78 that are storing memory management attribute data for the context concerned. The registers 76, 78 provide the translation lookaside buffer.

FIG. 14 is a further variant of a translation buffer unit. In this example there are again two sets of context parameter data stored. A single set of registers 80 stores the memory management attribute data. Each entry within the registers 80 is marked with a flag indicating whether the memory management attribute data entry concerned relates to the first set of context parameter data or the second set of context parameter data.

It will be appreciated that in the examples of FIGS. 12 and 13 two sets of context parameter data show as having been stored. However, a different number of sets of context parameter data may be stored either with a matching number of banks of registers storing the memory management attribute data or appropriate fields within the memory management attribute data entries identifying the associated set of context parameter data.

FIG. 15 illustrates a further variant of a translation buffer unit. In this example, each entry within the translation lookaside buffer 82 includes both the memory management attribute data and the context parameter data associated with that entry. This provides a high degree of granularity, but does require extra storage space for the context parameter data associated with each memory management attribute data entry.

It will be appreciated that there is a spectrum provided in the embodiments of FIGS. 12 to 15 varying from a single set of context parameter data associated with all of the memory management attribute data of that translation buffer unit through to each individual memory management attribute data entry having its own associated and individually configurable set of context parameter data. The trade-off between the granularity of control versus the storage space requirements may be judged on the individual circumstances where the translation buffer unit is required for use.

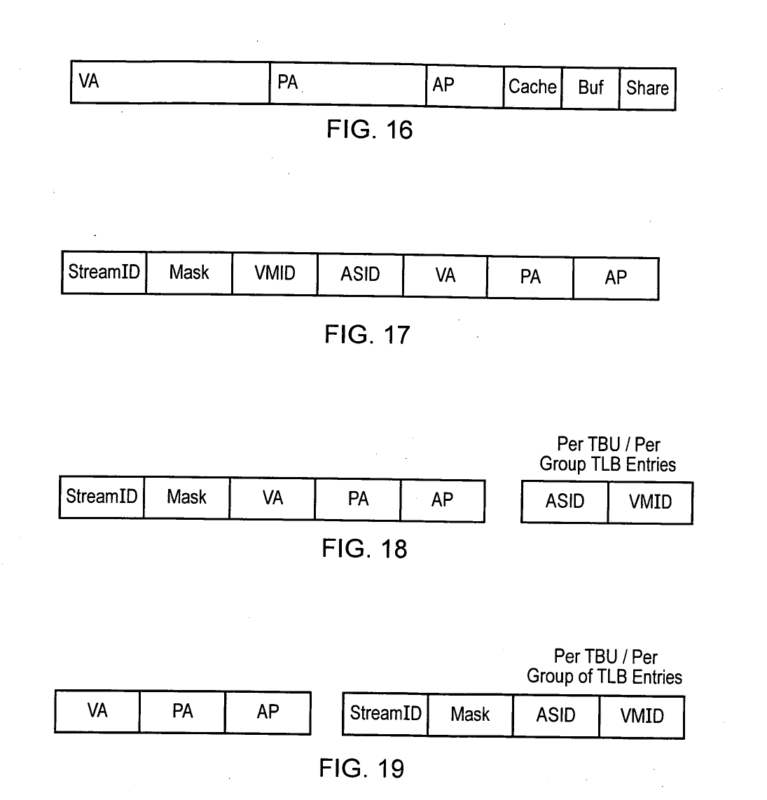

FIGS. 16 to 19 illustrate different example forms of memory management attribute data that may be stored. The memory management attribute data may include virtual addresses VA, physical addresses PA, access permissions AP, stream identifier values StreamID, stream mask values Mask, virtual machine identifiers VMID, application space identifiers ASID, and memory attributes such as cacheability, bufferability, and shareability configuration. It is also possible that the entries may store a context index value identifying a memory management context associated with the memory management attribute entry concerned.

FIGS. 16 and 17 show individual memory management attribute data entries within the translation lookaside buffer. In the example of FIG. 16 only the virtual address to physical address mapping data, the access permission data and memory attributes of cacheability, bufferability and shareability are stored. In the example of FIG. 17 each individual memory management attribute data entry stores the data of FIG. 16 and additionally stores the stream identifier value, the stream mask value, the virtual machine identifier and the application space identifier.

In the example of FIG. 18 the individual memory management attribute data entry store the stream identifier value, the stream mask value, the virtual to physical address mapping information and the access permission data. In addition either on a per translation buffer unit basis or on a per group of translation lookaside buffer entries basis there is stored the application space identifier and the virtual machine identifier.

FIG. 19 is similar to that of FIG. 18 except that the stream identifier value and the stream mask value have moved from being stored within each memory management attribute data entry into the data fields stored as the context parameter data entries on a per translation buffer unit basis or per group of translation lookaside buffer entries basis.

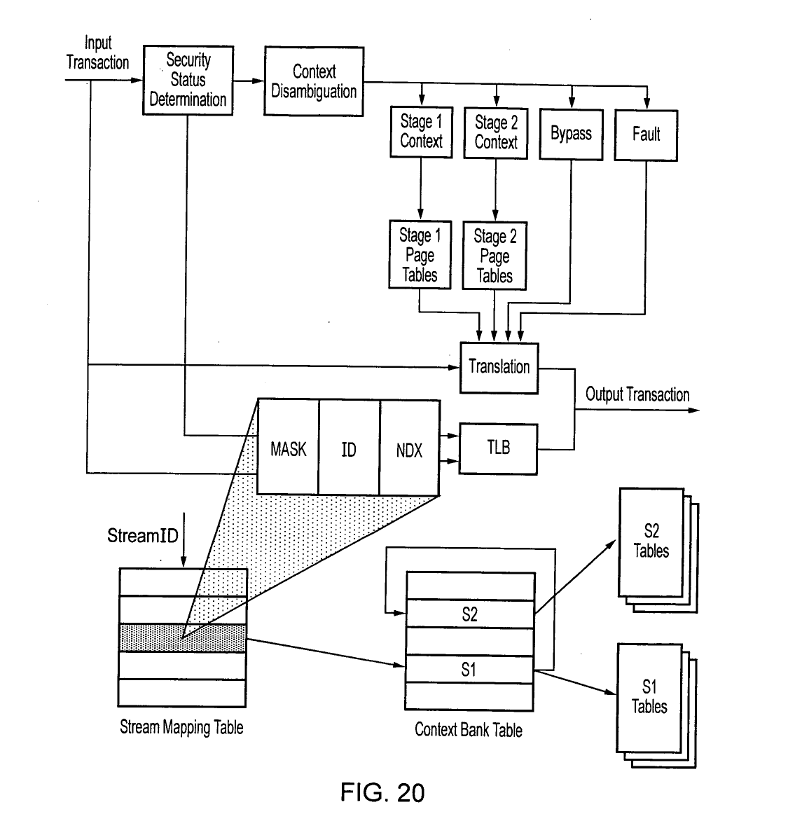

FIG. 20 schematically illustrates the process flow within a memory management unit. At a first stage the security status of an input memory transaction is determined. This security status may, for example, correspond to whether the memory transaction originates from within the secure domain or the non-secure domain of a TrustZone enabled processor of the type produced by ARM Limited of Cambridge, England.

The next stage is context disambiguation. This may be performed by context disambiguation circuitry which includes a stream mapping table. Each entry within the stream mapping table is capable of providing a mapping between at least one stream identifier and a memory management context (context parameter data) to be used within memory transactions matching that stream identifier.

The stream identifier may comprise a stream identifier value and a stream mask value. The stream mask value may be used to control which parts of a stream identifier value are significant when determining a match with that stream identifier value. The stream mask value may accordingly be a bit mask to be applied to received stream identifier values and the stored stream identifier values when comparing these to determine whether or not they match.

The processing proceeds using one or more of a stage one or a stage two translation contexts with associated page table data. A management bypass and a memory access fault route are also provided. Translation and translation lookaside buffer translation operations are performed before the final output transaction from the memory management unit is generated.

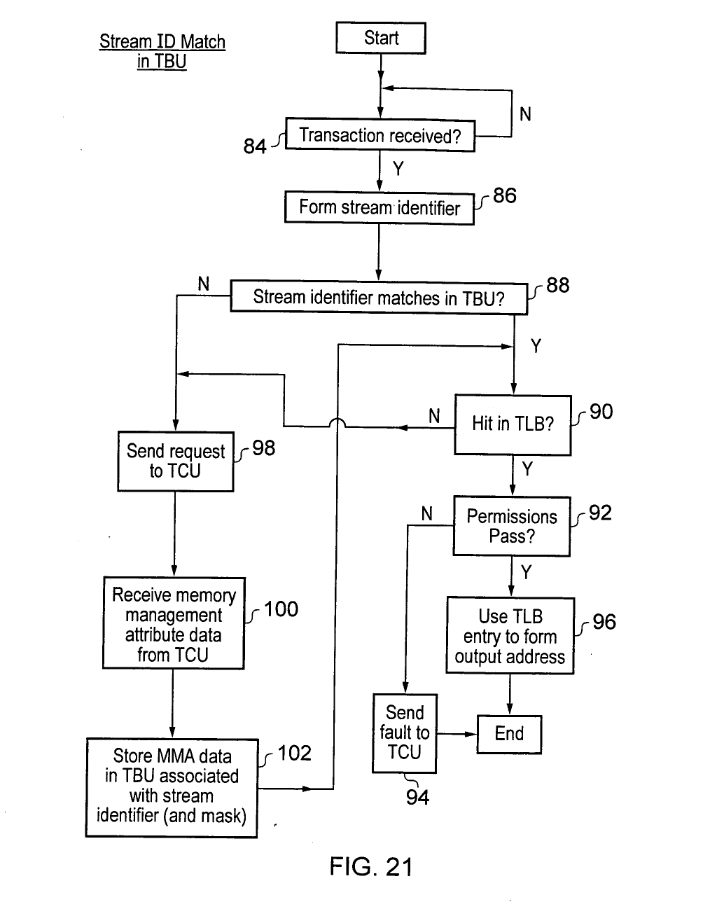

FIG. 21 schematically illustrates the processing performed in a translation buffer unit in order to match a stream identifier. Processing waits at step 84 until a memory transaction is received. Step 86 then forms the stream identifier from the received memory transaction. The memory transaction may itself include the stream identifier, or it may be that the stream identifier is formed within the translation buffer unit using signals contained within the received memory transaction. At step 88 a determination is made as to whether or not the stream identifier matches the stream identifier held in respect of that translation buffer unit. This example assumes that the translation buffer unit is of the form illustrated in FIG. 12 where a single set of context parameter data applies to the whole translation buffer unit and accordingly a single stream identifier is associated with the whole translation buffer unit.

If a match occurs at step 88, then step 90 determines whether or not there is a hit within the translation lookaside buffer for the memory address of the received memory transaction. If there is a hit, then step 92 determines whether or not the application permission data for that memory management attribute entry within the translation lookaside buffer matches the received memory transaction. If there is not a permission pass, then processing proceeds to step 94 where a fault indication is sent to the translation control unit and a fault response, such recording the fault and/or raising an interrupt request is triggered.

If the permissions pass then step 96 serves to use the translation lookaside buffer entry in which a hit was found to generate the output memory transaction which is output from the memory management unit.

If the determination at step 88 was that the stream identifier did not match or the determination at step 90 was that there was no hit within the translation lookaside buffer, then processing proceeds to step 98 where a request is sent to the translation control unit to return memory management attribute data that may be used to form the output address for the received memory transaction. At step 100 the memory management attribute data is received back from the translation control unit and at step 102 the memory management attribute data is stored within the translation buffer unit associated with the stream identifier for the memory transaction. Processing then proceeds to step 90 where a translation buffer hit will occur.

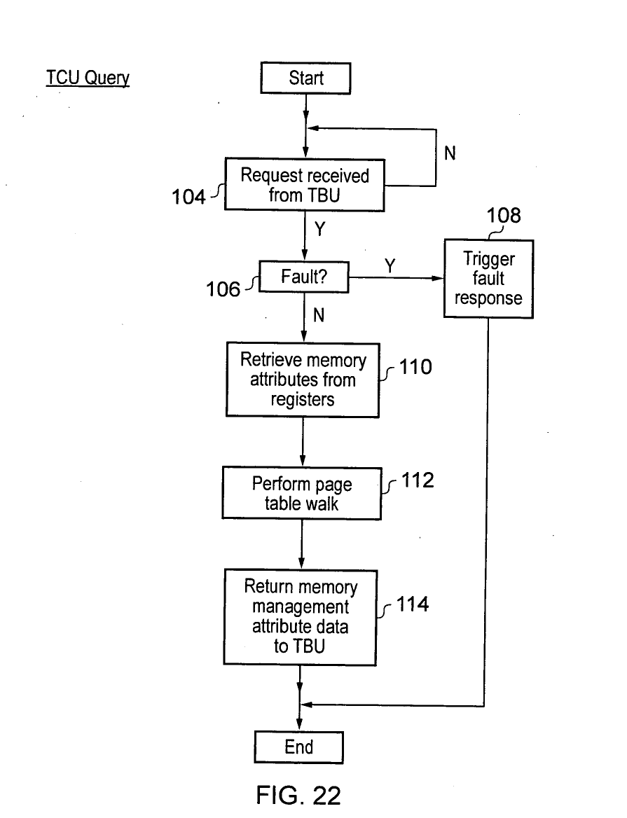

FIG. 22 is a flow diagram schematically illustrating the response of the translation control unit to receipt of a query. Processing waits at step 104 for a query to be received. Step 106 determines whether or not the received query indicates a fault. If a fault is indicated, then step 108 triggers a fault response. If the determination at step 136 is that the query is not a fault, then step 110 retrieves at least a portion of the memory management attribute data associated with that query from the context parameter data which is stored within registers within the translation control unit. Step 112 then performs a page table walk through page table data (possibly accessed using the retrieved data at step 110) to form the Rill set of memory attribute data to be returned to the translation buffer unit at step 114. The data returned to the translation buffer unit at step 114 may also include context parameter data, such as a stream identifier value and a stream mask value to be associated with that memory management attribute data.

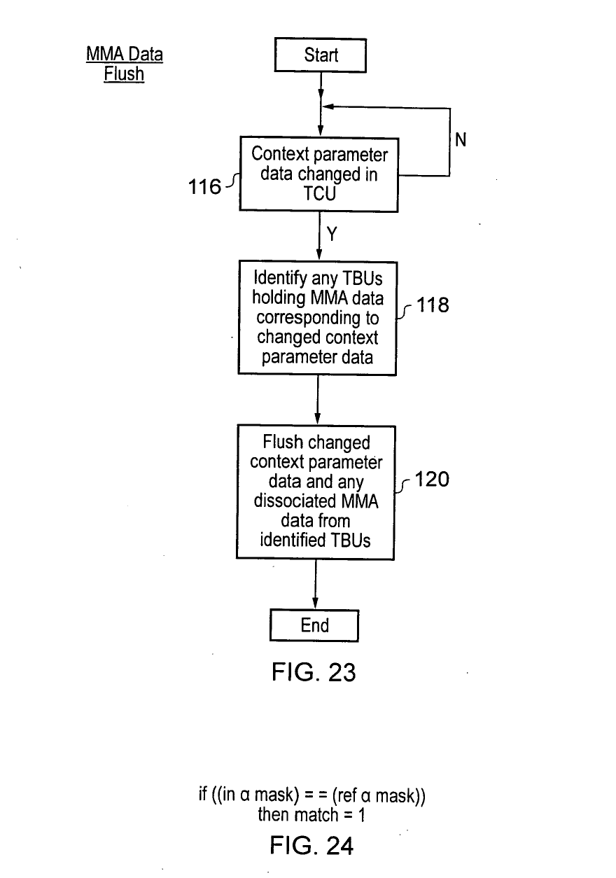

FIG. 23 schematically illustrates the flushing of memory management attribute data from a translation buffer unit. At step 116 a determination is made that some context parameter data has been changed within the translation control unit. Such context parameter data may be changed under program control such as by an operating system program or a hypervisor program. When such a change is detected, then step 118 serves to identify any translation buffer units which are holding memory management attribute data corresponding to the changed context parameter data. Such translation buffer units may be identified using data recorded within the translation control unit or the translation control unit may, for example, broadcast a message to all of its associated translation buffer units indicating the context parameter data that has changed. At step 120 within the identified translation buffer units both any stored context parameter data corresponding to that changed at step 116 and the associated memory management attribute data are flushed from the translation buffer units concerned.

FIG. 24 schematically illustrates in pseudocode form the comparison of a received stream identifier value “in” with a stored stream identifier value “ref” using a stream mask value “mask” and a bitwise comparison. Each of the stream identifier values is first bitwise ANDed with the stream mask value and the two resulting values are compared to determine if they are the same. If they are the same, then this indicates a match between the stream identifiers. This comparison may be performed within the translation buffer units when comparing a further stream identifier with a stream identifier previously stored within the translation buffer unit.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A memory management unit for managing memory accesses using a plurality of different memory management contexts, each of said plurality of different memory management contexts defining how memory access is controlled for memory transactions associated therewith, said memory management unit comprising:
a translation buffer unit having a translation lookaside buffer configured to store a plurality of memory management attributes entries to be applied to transactions received from one or more transaction masters prior to being sent to one or more transaction slaves, said memory management attributes comprising at least one of address translation attributes, memory access attributes and access permission attributes; and
context disambiguation circuitry configured to respond to one or more characteristics of a memory transaction received from one of said one or more transactions masters to form a stream identifier and to determine which of said plurality of different memory management contexts is a matching context to be used with memory transactions having said stream identifier such that memory management attributes entries stored within said translation lookaside buffer for use with said memory transaction are formed under control of said matching context; wherein
said translation buffer unit is configured to store at least a portion of said stream identifier produced by said context disambiguation circuitry, to respond to one or more characteristics of a further memory transaction received by said translation buffer unit to form a further stream identifier therefrom and, if said further stream identifier matches said stream identifier, then to use for said further memory transaction any memory management attributes entries stored within said translation lookaside buffer corresponding to said stream identifier.

2. A memory management unit as claimed in claim 1, wherein said context disambiguation circuitry is part of a translation control unit, said translation control unit being configured to perform a page table walk operation using page table data stored in a memory to determine at least part of one of said memory management attributes entries.

3. A memory management unit as claimed in claim 1, wherein said context disambiguation circuitry comprises a stream mapping table, each entry within said stream mapping table is able to provide a mapping between at least one stream identifier and a memory management context to be used with memory transactions matching said stream identifier.

4. A memory management unit as claimed in claim 1, wherein said stream identifier stored within said translation buffer unit comprises a stream identifier value and a stream mask value, said stream mask value controlling which parts of said stream identifier value are significant when determining a match with said stream identifier value.

5. A memory management unit as claimed in claim 1, wherein each memory management attributes entry within said translation lookaside buffer stores a stream identifier associated with said memory management attributes entry.

6. A memory management unit as claimed in claim 1, wherein said translation buffer unit stores a plurality of stream identifiers each associated with one or more memory management attributes entries within said translation lookaside buffer, at least one of said plurality of stream identifiers being associated with a plurality of memory management attribute entries.

7. A memory management unit as claimed in claim 1, wherein said translation buffer unit stores a single stream identifier associated with all memory management attributes entries within said translation lookaside buffer and, if said further stream identifier does not match said stream identifier, then at least one of: all memory management attributes entries within said translation lookaside buffer are flushed; and a memory transaction associated with said context parameter data entry that is modified is sent elsewhere for processing.

8. A memory management unit as claimed in claim 1 each memory management attributes entry within said translation lookaside buffer stores a context index value identifying a memory management context associated with said memory management attributes entry.

9. A memory management unit as claimed in claim 1, wherein said translation buffer unit stores a plurality of context index values each identifying a memory management context associated with one or more memory management attributes entries within said translation lookaside buffer, at least one of said plurality of context index values being associated with a plurality of memory management attribute entries.

10. A memory management unit as claimed in claim 1, wherein said translation buffer unit stores a single context index value identifying a memory management context associated with all memory management attributes entries within said translation lookaside buffer and, if said context disambiguation circuitry detects a change in memory management context of memory transactions to be processed by said translation buffer unit, then all memory management attributes entries within said translation lookaside buffer are flushed.

11. A memory management unit as claimed in claim 1 each memory management attributes entry within said translation lookaside buffer stores an application space identifier identifying a thread of program execution associated with said memory management attributes entry.

12. A memory management unit as claimed in claim 1, wherein said translation buffer unit stores a plurality of application space identifiers each identifying a thread of program execution associated with one or more memory management attributes entries within said translation lookaside buffer, at least one of said plurality of application space identifiers being associated with a plurality of memory management attribute entries.

13. A memory management unit as claimed in claim 1, wherein said translation buffer unit stores a single application space identifier identifying a thread of program execution associated with all memory management attributes entries within said translation lookaside buffer and, if said context disambiguation circuitry detects a change in application space identifier of memory transactions to be processed by said translation buffer unit, then all memory management attributes entries within said translation lookaside buffer are flushed.

14. A memory management unit as claimed in claim 1 each memory management attributes entry within said translation lookaside buffer stores a virtual machine identifier identifying a virtual machine execution environment associated with said memory management attributes entry.

15. A memory management unit as claimed in claim 1, wherein said translation buffer unit stores a plurality of virtual machine identifiers each identifying a virtual machine execution environment associated with one or more memory management attributes entries within said translation lookaside buffer, at least one of said plurality of virtual machine identifiers being associated with a plurality of memory management attribute entries.

16. A memory management unit as claimed in claim 1, wherein said translation buffer unit stores a single virtual machine identifier identifying a virtual machine execution environment associated with all memory management attributes entries within said translation lookaside buffer and, if said context disambiguation circuitry detects a change in virtual machine execution environment of memory transactions to be processed by said translation buffer unit, then all memory management attributes entries within said translation lookaside buffer are flushed.

17. A memory management unit as claimed in claim 1, wherein a plurality of transaction masters is coupled to said memory management unit.

18. A memory management unit as claimed in claim 2, comprising a plurality of translation buffer units each associated with a different transaction master and a shared translation control unit connected via a communication channel to said plurality of translation buffer units.

19. A memory management unit for managing memory accesses using a plurality of different memory management contexts, each of said plurality of different memory management contexts defining how memory access is controlled for memory transactions associated therewith, said memory management unit comprising:
translation buffer means for buffering translation data and having translation lookaside buffer means for storing a plurality of memory management attributes entries to be applied to transactions received from one or more transaction masters prior to being sent to one or more transaction slaves, said memory management attributes comprising at least one of address translation attributes, memory access attributes and access permission attributes; and
context disambiguation means for responding to one or more characteristics of a memory transaction received from one of said one or more transactions masters to form a stream identifier and to determine which of said plurality of different memory management contexts is a matching context to be used with memory transactions having said stream identifier such that memory management attributes entries stored within said translation lookaside buffer means for use with said memory transaction are formed under control of said matching context; wherein
said translation buffer means is configured to store at least a portion of said stream identifier produced by said context disambiguation means, to respond to one or more characteristics of a further memory transaction received by said translation buffer unit to form a further stream identifier therefrom and, if said further stream identifier matches said stream identifier, then to use for said further memory transaction any memory management attributes entries stored within said translation lookaside buffer corresponding to said stream identifier.

20. A method of operating a memory management unit for managing memory accesses using a plurality of different memory management contexts, each of said plurality of different memory management contexts defining how memory access is controlled for memory transactions associated therewith, said method comprising the steps of:
buffering translation data within a translation buffer unit having a translation lookaside buffer storing a plurality of memory management attributes entries to be applied to transactions received from one or more transaction masters prior to being sent to one or more transaction slaves, said memory management attributes comprising at least one of address translation attributes, memory access attributes and access permission attributes;
responding to one or more characteristics of a memory transaction received by context disambiguation circuitry from one of said one or more transactions masters by forming a stream identifier and determining which of said plurality of different memory management contexts is a matching context to be used with memory transactions having said stream identifier such that memory management attributes entries stored within said translation lookaside buffer for use with said memory transaction are formed under control of said matching context;
storing at least a portion of said stream identifier produced by said context disambiguation circuitry within said translation buffer unit;
responding to one or more characteristics of a further memory transaction received by said translation buffer unit to form a further stream identifier therefrom; and
if said further stream identifier matches said stream identifier, then using for said further memory transaction any memory management attributes entries stored within said translation lookaside buffer corresponding to said stream identifier.

21. A memory management unit for managing memory accesses using a plurality of different memory management contexts, each of said plurality of different memory management contexts defining how memory access is controlled for memory transactions associated therewith, said memory management unit comprising:
a translation buffer unit having a translation lookaside buffer configured to store a plurality of memory management attributes entries to be applied to transactions received from one or more transaction masters prior to being sent to one or more transaction slaves, said memory management attributes comprising at least one of address translation attributes, memory access attributes and access permission attributes; wherein
said translation buffer unit stores one or more context parameter data entries at least partially identifying memory management attributes associated with a plurality memory management attributes entries within said translation lookaside buffer and, if a context parameter data entry is modified, then at least one of: all memory management attributes entries associated with said context parameter data entry within said translation lookaside buffer are flushed; and a memory transaction associated with said context parameter data entry that is modified is sent elsewhere for processing.

22. A memory management unit as claimed in claim 21, comprising context disambiguation circuitry configured to respond to one or more characteristics of a memory transaction received from one of said one or more transactions masters to form a stream identifier and to determine which of said plurality of different memory management contexts is a matching context to be used with memory transactions having said stream identifier such that memory management attributes entries stored within said translation lookaside buffer for use with said memory transaction are formed under control of said matching context.

23. A memory management unit as claimed in claim 22, wherein said translation buffer unit is configured to store said stream identifier, to respond to one or more characteristics of a further memory transaction received by said translation buffer unit to form a further stream identifier therefrom and, if said further stream identifier matches said stream identifier, then to use for said further memory transaction any memory management attributes entries stored within said translation lookaside buffer corresponding to said stream identifier.

24. A memory management unit as claimed in claim 22, wherein said stream identifier comprises a stream identifier value and a stream mask value, said stream mask value controlling which parts of said stream identifier value are significant when determining a match with said stream identifier value.

25. A memory management unit as claimed in claim 22, wherein said context parameter data at least partially comprises said stream identifier.

26. A memory management unit as claimed in claim 21, wherein said context parameter data comprises at least one of:
a context index value identifying a memory management context associated with a plurality of memory management attributes entries within said translation lookaside buffer;
an application space identifier identifying a thread of program execution associated with a plurality of memory management attributes entries within said translation lookaside buffer; and
a virtual machine identifier identifying a virtual machine execution environment associated with a plurality of memory management attributes entries within said translation lookaside buffer.

27. A memory management unit as claimed in claim 21, wherein a plurality of transaction masters as coupled to said memory management unit.

28. A memory management unit as claimed in claim 22, comprising a translation control unit configured to perform a page table work operation through page table data stored in a memory to determine at least part of each of said memory management attributes entries and a plurality of translation buffer units each associated with a different transaction master, said translation control unit being a shared translation control unit connected via a communication channel to all of said plurality of translation buffer units.

29. A memory management unit for managing memory accesses using a plurality of different memory management contexts, each of said plurality of different memory management contexts defining how memory access is controlled for memory transactions associated therewith, said memory management unit comprising:
translation buffer means for buffering translation data and having translation lookaside buffer means for storing a plurality of memory management attributes entries to be applied to transactions received from one or more transaction masters prior to being sent to one or more transaction slaves, said memory management attributes comprising at least one of address translation attributes, memory access attributes and access permission attributes; wherein
said translation buffer means stores one or more context parameter data entries at least partially identifying memory management attributes associated with a plurality of memory management attributes entries within said translation lookaside buffer means and, if a context parameter data entry is modified, then at least one of all memory management attributes entries associated with said context parameter data entry said within said translation lookaside buffer means are flushed; and a memory transaction associated with said context parameter data entry that is modified is sent elsewhere for processing.

30. A method of operating a memory management unit for managing memory accesses using a plurality of different memory management contexts, each of said plurality of different memory management contexts defining how memory access is controlled for memory transactions associated therewith, said method comprising the steps of
buffering translation data within a translation buffer unit having a translation lookaside buffer for storing a plurality of memory management attributes entries to be applied to transactions received from one or more transaction masters prior to being sent to one or more transaction slaves, said memory management attributes comprising at least one of address translation attributes, memory access attributes and access permission attributes;
storing within said translation buffer unit one or more context parameter data entries at least partially identifying memory management attributes associated with a plurality of memory management attributes entries within said translation lookaside buffer; and
if a context parameter data entry is modified, then at least one of: flushing all memory management attributes entries associated with said context parameter data entry within said translation lookaside buffer means; and sending elsewhere for processing a memory transaction associated with said context parameter data entry that is modified.
